(19) United States
(12) Patent Application Publication
(10) Pub. No.: US 2025/0074078 A1
(43) Pub. Date: Mar. 6, 2025

(54) INK JET RECORDING APPARATUS

(71) Applicant: CANON KABUSHIKI KAISHA, Tokyo (JP)

(72) Inventor: YOSUKE OBAYASHI, Chiba (JP)

(21) Appl. No.: 18/815,651

(22) Filed: Aug. 26, 2024

(30) Foreign Application Priority Data
Aug. 30, 2023 (JP) 2023-140541

(51) Int. Cl. B41J 11/00

(52) U.S. Cl. CPC B41J 11/0024

(57) ABSTRACT

An ink jet recording apparatus includes an ink image forming unit, and a fixing apparatus, wherein the fixing apparatus includes a first belt configured to come into contact with an ink image, a rotating member configured to come into contact with the first belt to form a nip portion, a heater arranged inside the first belt and configured to heat the nip portion without contact, a reflector configured to cover an upper portion of the heater and to reflect radiant heat from the heater toward an inner circumferential surface of the first belt, an opening formed on the reflector, and a temperature detection member arranged inside the first belt and configured to detect a temperature of a heating area of the heater on the first belt without contact, wherein the temperature detection member is arranged to detect a temperature of the first belt from the opening.

### FIELD

The present disclosure relates to an ink jet recording apparatus that fixes an image formed with ink on a sheet.

### DESCRIPTION OF THE RELATED ART

If a user touches a recording medium on which ink has not yet dried immediately after being recorded by an ink jet recording apparatus, an image may be blurred, or the ink may adhere to user's hands. In a case of an ink jet recording apparatus of which a recording speed is high, a second recording medium may be stacked on a first recording medium before ink thereon dries, and a back side of the second recording medium may be smeared. Thus, ink jet recording apparatuses, particularly high speed recording models, require means for drying and fixing ink on a recording medium.

Ink jet recording apparatuses adopt a heat fixing method for heating a recording medium immediately after recording as means for drying and fixing ink. According to Japanese Patent Application Laid-Open No. 2010-201817, a configuration is discussed, which forms a nip portion by a roller pair to perform fixing.

In a case of the configuration in which a recording medium carrying an ink image passes through the nip portion formed between the roller pair to fix the ink image, a width of the recording medium in a conveyance direction is small. Thus, it is necessary to set a temperature of a fixing unit high. This may cause the ink image to evaporate, resulting in an image defect. Therefore, a configuration in which a nip portion is formed by belts is suggested.

### SUMMARY

According to some embodiments, an ink jet recording apparatus includes an ink image forming unit configured to form an ink image on a recording medium, and a fixing apparatus arranged downstream of the ink image forming unit in a conveyance direction of the recording medium and configured to fix the ink image on the recording medium while pinching and conveying the recording medium, wherein the fixing apparatus includes a first belt configured to rotate and come into contact with the ink image formed by the ink image forming unit, a rotating member configured to come into contact with the first belt to form a nip portion, a heater arranged inside the first belt and configured to heat the nip portion without contact, a reflector configured to cover an upper portion of the heater and to reflect radiant heat from the heater toward an inner circumferential surface of the first belt in the nip portion, an opening formed on the reflector, and a temperature detection member arranged inside the first belt and configured to detect a temperature of a heating area of the heater on the first belt without contact, wherein the temperature detection member is arranged to detect a temperature of the first belt from the opening.

Further features of the present disclosure will become apparent from the following description of exemplary embodiments with reference to the attached drawings.

### BRIEF DESCRIPTION OF THE DRAWINGS

FIG. 1 is a schematic diagram illustrating an ink jet recording apparatus according to an exemplary embodiment.

FIG. 2 is a configuration diagram illustrating an overall fixing apparatus.

FIGS. 3A and 3B are block diagrams illustrating a system configuration regarding abnormal temperature detection of the fixing apparatus.

FIGS. 4A and 4B are flowcharts illustrating fixing control of the fixing apparatus.

FIGS. 5A to 5C illustrate a structure and a viewing angle of a temperature sensor.

FIGS. 6A and 6B illustrate conventional examples.

FIGS. 7A and 7B illustrate an arrangement of a temperature sensor and a shape of a reflector according to a first exemplary embodiment.

FIGS. 8A and 8B illustrate an arrangement of a temperature sensor and a shape of a reflector according to a second exemplary embodiment.

### DESCRIPTION OF THE EMBODIMENTS

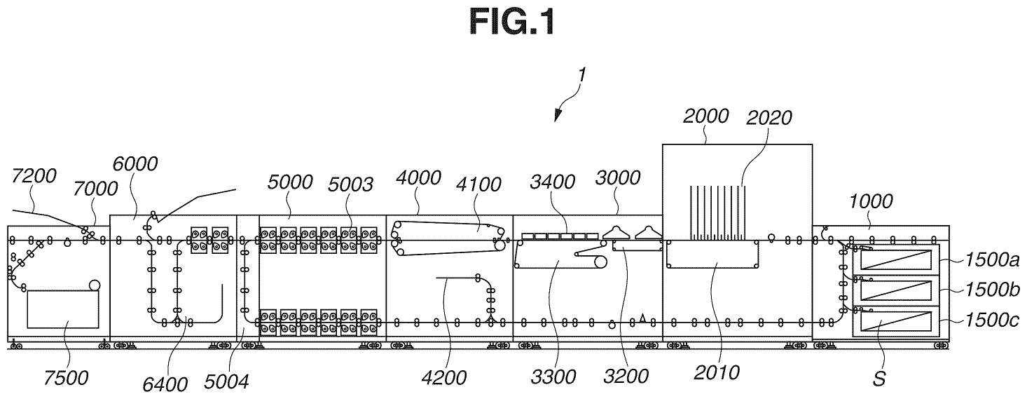

Various exemplary embodiments, features, and aspects of the present disclosure will be described with reference to the attached drawings. First, a schematic configuration of an image forming system according to the present exemplary embodiment is described with reference to FIG. 1.

### Image Forming System

An ink jet recording apparatus 1 according to the present exemplary embodiment adopts an ink jet recording method for ejecting ink to form an image on a recording medium. An ink image is formed on a recording medium using two liquids, a reaction solution and ink. A recording medium S may be any recording medium that can accept ink, such as plain paper, thick paper, a plastic film for an overhead projector, a special shape recording medium such as an envelope or index paper, or cloth.

As illustrated in FIG. 1, the ink jet recording apparatus 1 according to the present exemplary embodiment is an example of an image forming apparatus and includes a feeding module 1000, an ink image forming unit 2000, and a drying module 3000. The ink jet recording apparatus 1 further includes a fixing apparatus 4000, a cooling module 5000, a reversing module 6000, and a stacking module 7000. The recording medium S fed from the feeding module 1000 is subjected to various types of processing as it is conveyed along a conveyance path in each module and is finally discharged to the stacking module 7000.

The feeding module 1000 to the stacking module 7000 may have respective separate housings, and these housings may be connected to form the ink jet recording apparatus 1.

Alternatively, the feeding module 1000 to the stacking module 7000 may be arranged in one housing.

The feeding module 1000 includes containers 1500a, 1500b, and 1500c that store the recording media S. The containers 1500a to 1500c can be pulled out toward a front side of the apparatus to store the recording media S. The recording media S are fed one by one by a separation belt and a conveyance roller from each of the containers 1500a to 1500c and conveyed to the ink image forming unit 2000. The feeding module 1000 is not limited to a configuration including three containers 1500a to 1500c, and may include one, two, or four or more containers.

The ink image forming unit 2000 includes a pre-image-forming registration correction unit, a print belt unit 2010, and a recording unit 2020 and forms an ink image by ejecting ink to the recording medium S. The recording medium S conveyed from the feeding module 1000 has its tilt and position corrected by the pre-image-forming registration correction unit and is conveyed to the print belt unit 2010. The recording unit 2020 is arranged at a position facing the print belt unit 2010 across the conveyance path. The recording unit 2020 is an ink jet recording unit that ejects ink using a recording head from above onto the recording medium S being conveyed to form an ink image. A plurality of recording heads that eject ink is arranged along a conveyance direction. According to the present exemplary embodiment, the recording unit 2020 includes a total of five line type recording heads corresponding to four colors of yellow (Y), magenta (M), cyan (C), and black (Bk) and to a reaction solution. The recording medium S is suctioned and conveyed by the print belt unit 2010, so that a clearance is secured with respect to the recording heads.

The number of ink colors and the number of recording heads are not limited to five described above. The ink jet recording method can include a method using a heating element, a method using a piezoelectric element, a method using an electrostatic element, and a method using a micro electro mechanical systems (MEMS) element. Ink of each color is supplied to the recording head from an ink tank (not illustrated) via an ink tube. The ink includes “0.1% to 20.0% by mass” of a resin component, water, a water-soluble organic solvent, a coloring material, a wax, and an additive based on the total mass of the ink.

The recording medium S on which an image is formed by the recording unit 2020 is detected by an inline scanner (not illustrated) arranged downstream of the recording unit 2020 in the conveyance direction of the recording medium S at the time of being conveyed by the print belt unit 2010. Here, deviation and color density of the image formed on the recording medium S are detected, and an image to be formed on the recording medium S and its density will be corrected based on the detected deviation and color density of the image.

The drying module 3000 is an example of a drying apparatus and blows hot air and dries the recording medium S on which the image is formed by the ejected ink. The drying module 3000 includes a decoupling unit 3200, a drying belt unit 3300, and a hot air blowing unit 3400. The drying module 3000 reduces liquid contents of the ink and reaction solution applied to the recording medium S in order to improve fixing property of the ink to the recording medium S in the subsequent fixing apparatus 4000. The recording medium S on which the image is formed is conveyed to the decoupling unit 3200 arranged within the drying module 3000. The decoupling unit 3200 generates a frictional force between the recording medium S and a belt due to pressure of a wind blowing from above and causes the belt to convey the recording medium S. The recording medium S placed on the belt is conveyed by the frictional force, and thus the recording medium S is prevented from deviating during conveyance from the print belt unit 2010 to the decoupling unit 3200. The recording medium S conveyed from the decoupling unit 3200 is suctioned and conveyed by the drying belt unit 3300, and the hot air blowing unit 3400 located above the belt blows the hot air and dries the ink and reaction solution applied to the recording medium S.

In this way, the drying module 3000 heats the ink and reaction solution applied to the recording medium S to promote evaporation of moisture therein. Accordingly, it is possible to suppress an occurrence of cockling where an ink portion absorbs ink applied to the recording medium S and causes paper to stretch and wrinkle locally. As a heater for heating the air, for example, a heating wire or an infrared heater is desirable from the viewpoint of safety and energy efficiency. In addition to the method for applying hot air, the drying method may be configured by combining a method for irradiating a surface of the recording medium S with an electromagnetic wave (an ultraviolet ray, an infrared ray, or the like) and a conductive heat transfer method by contact with a heating element.

The fixing apparatus 4000 includes a fixing belt unit 4100. The fixing belt unit 4100 passes the recording medium S, which is conveyed from the drying module 3000 and has the image formed thereon, through a nip portion formed between a heated first belt unit and a second belt unit.

Accordingly, the ink image is fixed to the recording medium S.

The cooling module 5000 includes a plurality of cooling units 5003, and the cooling unit 5003 cools the high temperature recording medium S conveyed from the fixing apparatus 4000. The cooling unit 5003 draws outside air into a cooling box using, for example, a fan to increase a pressure inside the cooling box and cools the recording medium S by blowing air thereto from the cooling box through a nozzle under pressure. The cooling units 5003 are arranged on both sides of the conveyance path of the recording medium S and cool both sides of the recording material S.

The cooling module 5000 is provided with a conveyance path switching unit 5004. The conveyance path switching unit 5004 switches the conveyance path of the recording medium S depending on a case where the recording medium S is conveyed to the reversing module 6000 or a case where the recording medium S is conveyed to a double-sided conveyance path for double-sided printing in which images are formed on both sides of the recording medium S.

The reversing module 6000 includes a reversing unit 6400. The reversing unit 6400 reverses the front and back of the recording medium S being conveyed to change the front and back of the recording medium S to be discharged to the stacking module 7000. The stacking module 7000 includes a top tray 7200 and a stacking unit 7500 and stacks the recording medium S conveyed from the reversing module 6000 thereon.

In double-sided printing, the recording medium S is conveyed to the conveyance path in a lower part of the cooling module 5000 by the conveyance path switching unit 5004. Then, the recording medium S passes through the double-sided conveyance path in the fixing apparatus 4000, the drying module 3000, the ink image forming unit 2000, and the feeding module 1000 and is returned to the ink image forming unit 2000. A double-sided conveyance unit of the fixing apparatus 4000 is provided with a reversing unit 4200 that reverses the front and back of the recording medium S. The recording medium S returned to the ink image forming unit 2000 has an image formed with ink on the other surface on which an image is not formed and is discharged from the drying module 3000 via the reversing module 6000 to the stacking module 7000.

### Fixing Apparatus

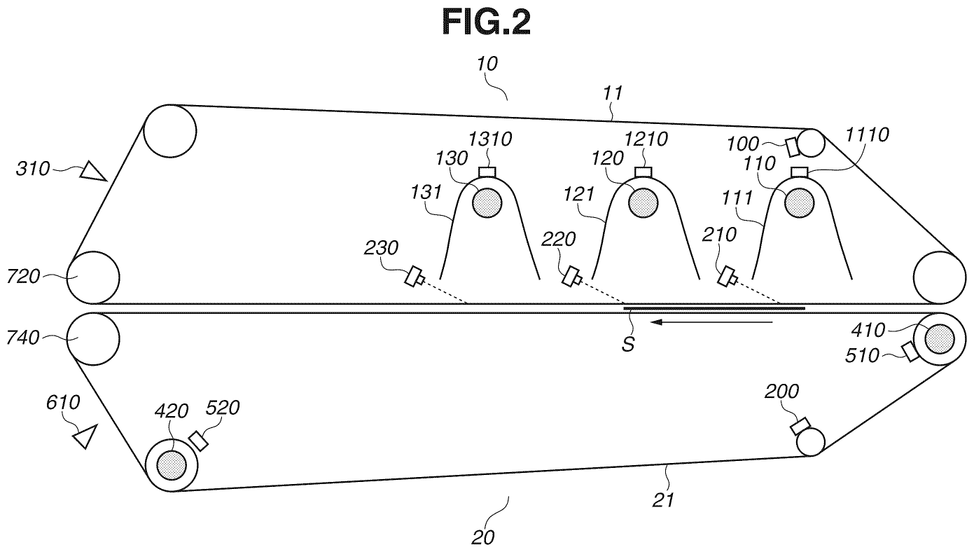

FIG. 2 is an overall configuration diagram illustrating the fixing apparatus 4000 including a first belt unit 10 and a second belt unit 20 in the ink jet recording apparatus 1. The ink jet recording apparatus 1 performs ink jet printing on the recording medium S, dries the moisture in the ink, and fixes it. A rotatable first belt 11 included in the first belt unit 10 is heated by a heat source and comes into contact with the recording medium S to heat it. A second belt 21, which is a rotating member included in the second belt unit 20, forms a nip portion by coming into contact with the first belt 11. The first belt 11 and the second belt 21 sandwich and convey the recording medium S therebetween to fix the ink thereon.

The first belt 11 and the second belt 21 are rotated by drive motors (not illustrated) serving as respective drive sources, and the recording medium S is conveyed in a direction of an arrow. The drive motor is connected to a first drive roller 720 and drives the first drive roller 720 to rotate, thereby rotating the first belt 11. The drive motor is connected to a second drive roller 740 and drives the second drive roller 740 to rotate, thereby rotating the second belt 21. The first drive roller 720 and the second drive roller 740 are rubber rollers with rubber surfaces. The first drive roller 720 and the second drive roller 740 are rubber rollers, so that they can increase a grip force on the belts and stably convey the belts.

### First Belt Unit

The first belt unit 10 includes heaters 110, 120, and 130, the first drive roller

720, temperature sensors 210, 220, and 230, which are temperature detection members arranged inside the first belt 11, and a temperature sensor 310 that controls a belt temperature.

The first belt 11 comes into contact with a front surface of the recording medium S on which the ink is applied by the ink image forming unit 2000. A first heater unit that heats an inner circumferential surface of the first belt 11 without contact is arranged to heat the ink image on the recording medium S. The first heater unit includes the heaters 110, 120, and 130, which are halogen heaters, and the heaters 110, 120, and 130 heat the inner circumferential surface of the first belt 11 without contact. The heaters 110, 120, and 130 are arranged side by side along the conveyance direction of the recording medium S. Further, the heaters 110, 120, and 130 heat the nip portion formed between the first belt 11 and the second belt 21. Thus, the heaters 110, 120, and 130 arranged inside the first belt 11 are arranged side by side along the conveyance direction in the nip portion. The nip portion according to the present exemplary embodiment is formed wide enough in the conveyance direction to be able to arrange the heaters 110, 120, and 130 along the conveyance direction.

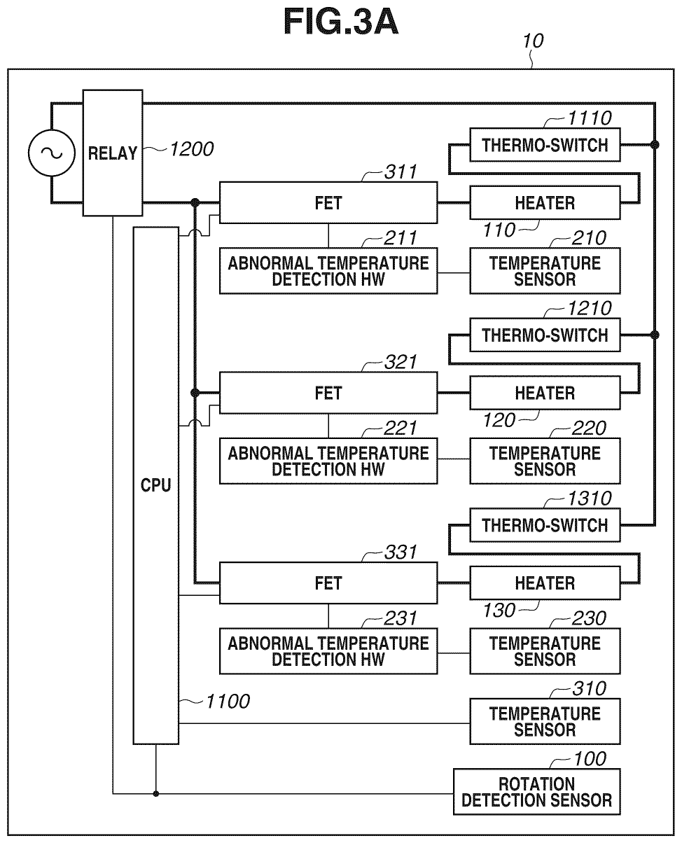

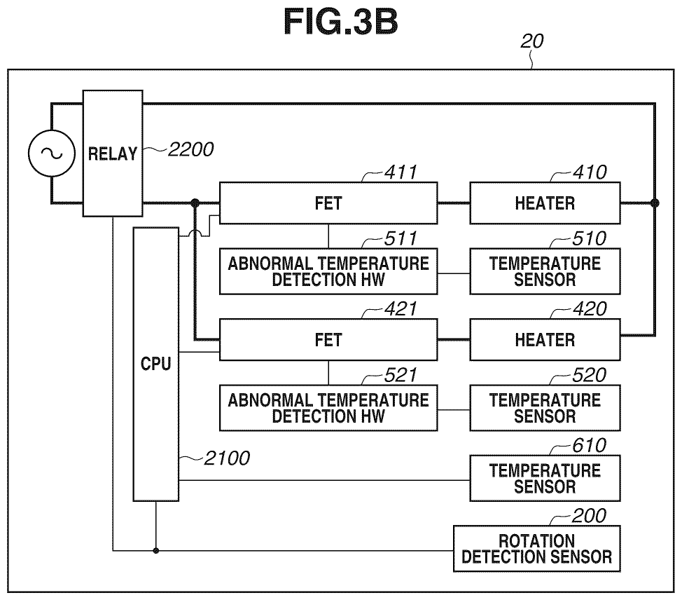

FIGS. 3A and 3B are hardware block diagrams illustrating the fixing apparatus 4000. FIG. 3A is the hardware block diagram of the first belt unit 10.

A central processing unit (CPU) 1100 drives field effect transistors (FETs) 311, 321, and 331 to control outputs of the heaters 110, 120, and 130. The CPU 1100 adjusts output amounts of the heaters 110, 120, and 130 by feeding back temperature information from the temperature sensor 310.

Abnormal temperature detection hardware (HW) 211, 221, and 231 detect that temperatures of the temperature sensors 210, 220, and 230 are a certain threshold value or higher and stop driving of the FETs 311, 321, and 331.

The threshold value for an abnormal temperature is a temperature that is set according to a material of the belt to prevent deformation, and is set to 150° C. in the present exemplary embodiment, but is not limited to this value. The CPU 1100 controls a temperature of the first belt 11 by driving the FETs 311, 321, and 331 based on a temperature detected by the temperature sensor 310. Thermo-switches 1110, 1210, and 1310 cut off power supply to the heaters 110, 120, and 130 if they detect abnormal heating temperatures in the heaters 110, 120, and 130. If a rotation detection sensor 100 detects that the first belt 11 stops rotating, it cuts off a relay 1200 to cause the heaters 110, 120, and 130 to stop heating.

FIG. 3B is the hardware block diagram of the second belt unit 20. The second belt unit 20 includes a CPU 2100, a relay 2200, FETs 411 and 421, abnormal temperature detection HW 511 and 521, heaters 410 and 420, and temperature sensors 510, 520, and 610. The CPU 2100 drives the FETs 411 and 421 to control outputs of the heaters 410 and 420. The CPU 2100 adjusts output amounts of the heaters 410 and 420 by feeding back temperature information from the temperature sensor 510.

The abnormal temperature detection HW 511 and 521 detect that temperatures of the temperature sensors 510 and 520 are a certain threshold value or higher and stop driving of the FETs 411 and 421. The threshold value for the abnormal temperature is a temperature that is set according to a material of the belt to prevent deformation, and is set to 150° C. in the present exemplary embodiment, but is not limited to this value.

The CPU 2100 adjusts the drive control of the FETs 411 and 421 that control the heaters 410 and 420 based on the temperature information from the temperature sensor 610. If a rotation detection sensor 200 detects that the second belt 21 stops rotating, it cuts off the relay 2200 to cause the heaters 410 and 420 to stop heating.

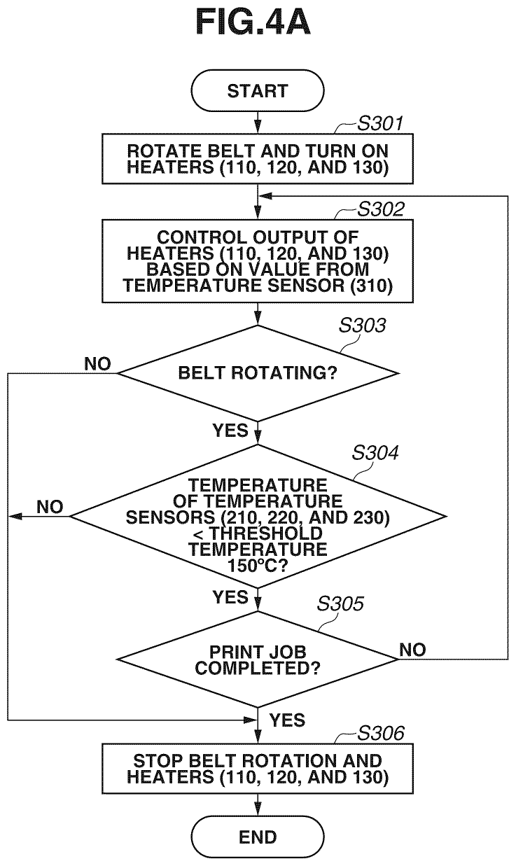

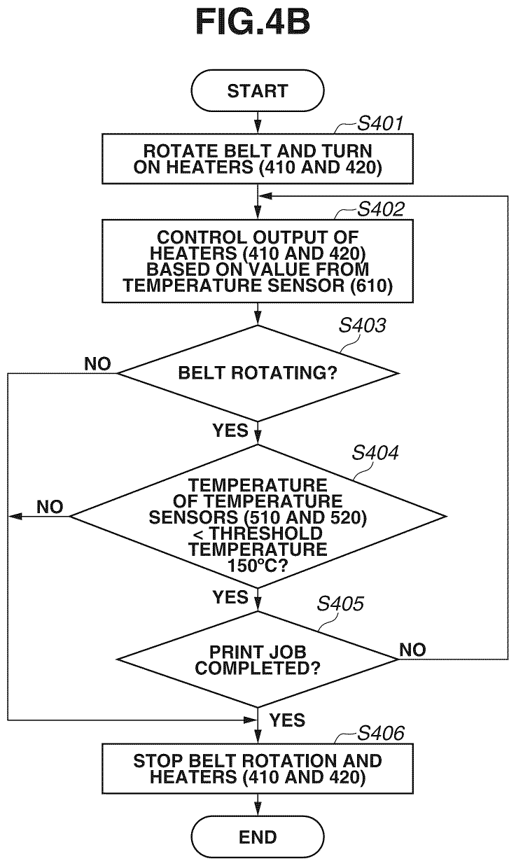

FIGS. 4A and 4B are flowcharts illustrating fixing control of the fixing apparatus 4000. FIG. 4A is the flowchart illustrating fixing control of the first belt unit 10. The fixing control of the fixing apparatus 4000 is described.

If the fixing control is started in the first belt unit 10, processing proceeds to step S301.

In step S301, the CPU 1100 controls the drive motor of an upper belt to rotate the belt and turns on the heaters 110, 120, and 130.

In step S302, the CPU 1100 reads a value of the temperature sensor 310 and controls the heaters 110, 120, and 130 to adjust the belt temperature. The belt temperature is adjusted at a constant temperature to maintain quality of a printing medium.

In step S303, the CPU 1100 determines whether the belt is rotating based on a value of the rotation detection sensor 100. If the CPU 1100 determines that the belt is rotating based on the value of the rotation detection sensor 100 (YES in step S303), the processing proceeds to step S304. If the CPU 1100 determines that the belt is not rotating based on the value of the rotation detection sensor 100 (NO in step S303), the processing proceeds to step S306.

In step S304, the CPU 1100 determines whether temperature values read from the temperature sensors 210, 220, and 230 are higher than a certain threshold temperature. According to the present exemplary embodiment, the threshold temperature is set to 150° C. In step S304, if the temperature values read by the CPU 1100 from the temperature sensors 210, 220, and 230 are the threshold temperature of 150° C. or higher (NO in step S304), the processing proceeds to step S306. In step S304, if the temperature values read by the CPU 1100 from the temperature sensors 210, 220, and 230 are lower than the threshold temperature of 150° C. (YES in step S304), the processing proceeds to step S305.

In step S305, the CPU 1100 determines whether a print job completion notification is received from a print job controller (not illustrated). In step S305, if the print job completion notification is received (YES in step S305), the processing proceeds to step S306. In step S305, if the print job completion notification is not received (NO in step S305), the processing returns to step S302.

In step S306, the CPU 1100 controls the drive motor of the upper belt to stop rotation of the belt and stops the heaters 110, 120, and 130.

The threshold temperature of 150° C. according to the present exemplary embodiment is merely an example and is not limited to this value.

FIG. 4B is the flowchart illustrating fixing control of the second belt unit 20. The fixing control of the second belt unit 20 is described.

If the fixing control is started in the second belt unit 20, the processing proceeds to step S401.

In step S401, the CPU 2100 controls the drive motor of a lower belt to rotate the belt and turns on the heaters 410 and 420.

In step S402, the CPU 2100 reads a value of the temperature sensor 610 and controls the heaters 410 and 420 to adjust the belt temperature. The belt temperature is adjusted at a constant temperature to maintain quality of a printing medium.

In step S403, the CPU 2100 determines whether the belt is rotating based on a value of the rotation detection sensor 200. If the CPU 2100 determines that the belt is rotating based on the value of the rotation detection sensor 200 (YES in step S403), the processing proceeds to step S404. If the CPU 2100 determines that the belt is not rotating based on the value of the rotation detection sensor 200 (NO in step S403), the processing proceeds to step S406.

In step S404, the CPU 2100 determines whether temperature values read from the temperature sensors 510 and 520 are higher than the certain threshold temperature. According to the present exemplary embodiment, the threshold temperature is set to 150° C. In step S404, if the temperature values read by the CPU 2100 from the temperature sensors 510 and 520 are the threshold temperature of 150° C. or higher (NO in step S404), the processing proceeds to step S406. In step S404, if the temperature values read by the CPU 2100 from the temperature sensors 510 and 520 are lower than the threshold temperature of 150° C. (YES in step S404), the processing proceeds to step S405.

In step S405, the CPU 2100 determines whether the print job completion notification is received from the print job controller (not illustrated). In step S405, if the print job completion notification is received (YES in step S405), the processing proceeds to step S406. In step S405, if the print job completion notification is not received (NO in step S405), the processing returns to step S402.

In step S406, the CPU 2100 controls the drive motor of the lower belt to stop rotation of the belt and stops the heaters 410 and 420.

The threshold temperature of 150° C. according to the present exemplary embodiment is merely an example and is not limited to this value.

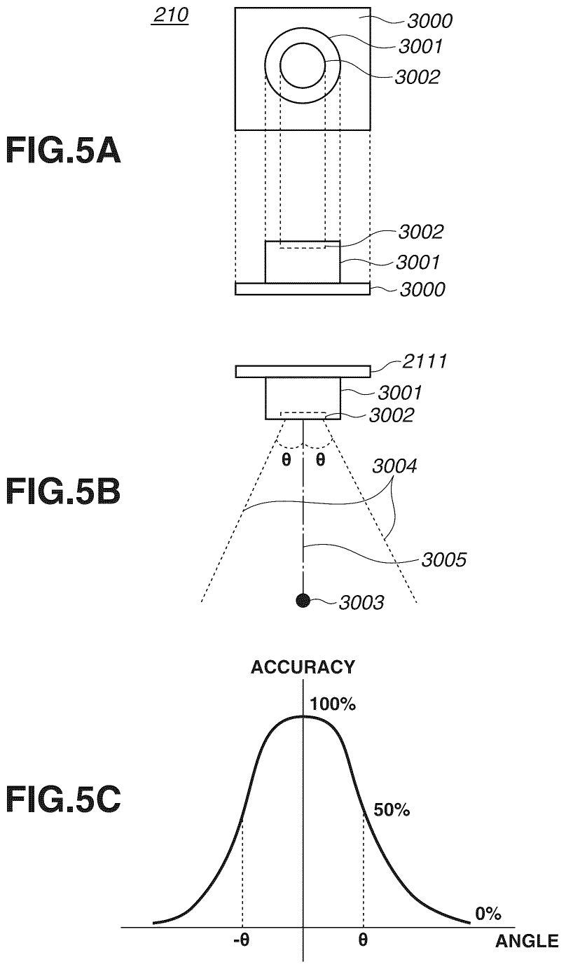

FIGS. 5A to 5C illustrate a configuration of the temperature sensor 210. FIG. 5A is an outline drawing of the temperature sensor 210. FIGS. 5B and 5C illustrate a viewing angle of the temperature sensor 210. A package 3001 in which a sensor module is incorporated is mounted on a substrate 2111, and has a detection window 3002 on top. The temperature sensor 210 absorbs infrared rays radiated from an object to be measured through the detection window 3002, converts the absorbed infrared energy into an electrical signal, and thus can detect a temperature without contact. FIG. 5B schematically illustrates the viewing angle of the temperature sensor 210. The detection window 3002 not only allows infrared rays to pass through to the inside of the package 3001 but also serves as a lens. In other words, the temperature sensor 210 has a constant viewing angle 3004 and detects a temperature of a measurement object 3003 within the viewing angle 3004 without contact. FIG. 5C illustrates a definition of the viewing angle 3004. Temperature measurement accuracy is 100% in a case where the measurement object 3003 is on a center line 3005 of the viewing angle 3004. Next, the measurement object 3003 is moved from the center line 3005 without changing a distance to the temperature sensor 210. An angle θ between the measurement object 3003 and the center line 3005 when the temperature measurement accuracy drops to 50% due to the movement is defined as the viewing angle 3004. The value of 50% according to the present exemplary embodiment is merely an example and is not limited to 50%.

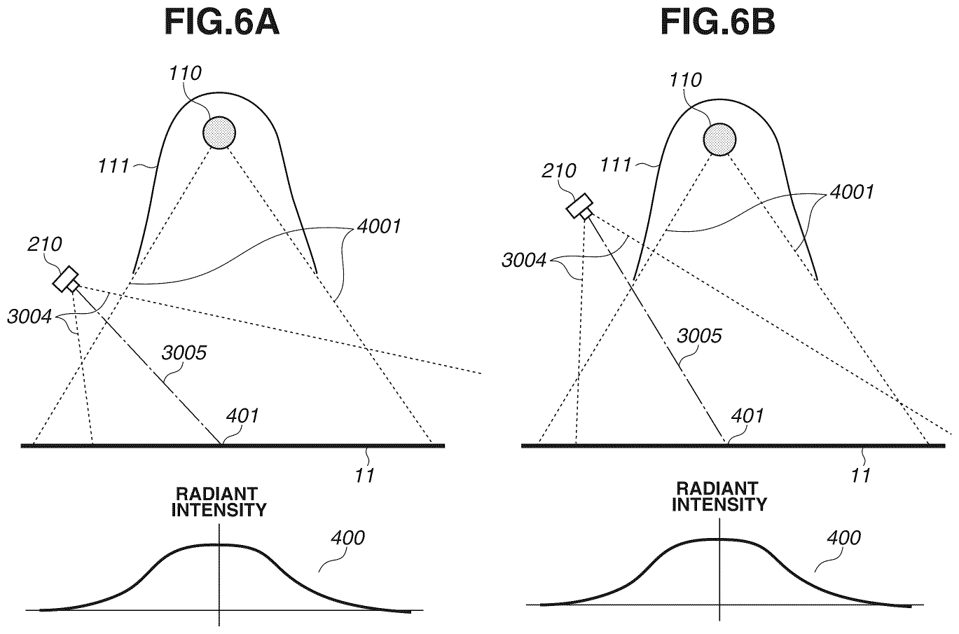

FIGS. 6A and 6B illustrate conventional examples regarding an arrangement of the temperature sensor 210. FIG. 6A illustrates an example of the arrangement of the temperature sensor 210. A reflector 111 reflects radiant heat radiated from the heater 110 and collects light toward the first belt 11 to heat the belt 11. A certain area (heating area) on the first belt 11 is heated in according to a shape of the reflector 111. A heating range 4001 has a heating intensity distribution 400 according to the shape of the reflector 111. The heating intensity is stronger toward the center 401 of light collected by the reflector 111 and decreases away from the center 401. According to the present exemplary embodiment, a range where the radiant heat from the heater 110 reaches the first belt 11 is referred to as a heating area. The temperature sensor 210 is arranged at a position outside the heating range 4001 of the heater 110. The center line 3005 of the viewing angle 3004 of the temperature sensor 210 is directed toward the center 401 of the light collected by the reflector 111, that is, a point on the heating intensity distribution 400 where the heating intensity is strongest. In addition, the temperature sensor 210 is arranged so that the reflector 111 does not interfere with the viewing angle 3004. In the example in FIG. 6A, not only does the viewing angle 3004 not fall within the heating area, but a far right side of the heating area in FIG. 6A is included in the viewing angle 3004. In this way, if an area other than an object of temperature detection is included in the viewing angle 3004, an issue arises that a temperature of a belt heating surface cannot be detected with high accuracy.

FIG. 6B illustrates another example of the arrangement of the temperature sensor 210. In the example in FIG. 6B, the temperature sensor 210 is arranged higher in order to make the heating area, which is the object of temperature detection, fall within the viewing angle 3004. In this way, the angle between the center line 3005 of the viewing angle 3004 of the temperature sensor 210 and the first belt 11 is set large, so that the heating area can fall within the viewing angle 3004 as much as possible. However, as illustrated, if the temperature sensor 210 is placed at a high position with an angle, an issue arises that the reflector 111 interferes with the viewing angle 3004. The interference causes an issue that the temperature of the heating area cannot be detected accurately.

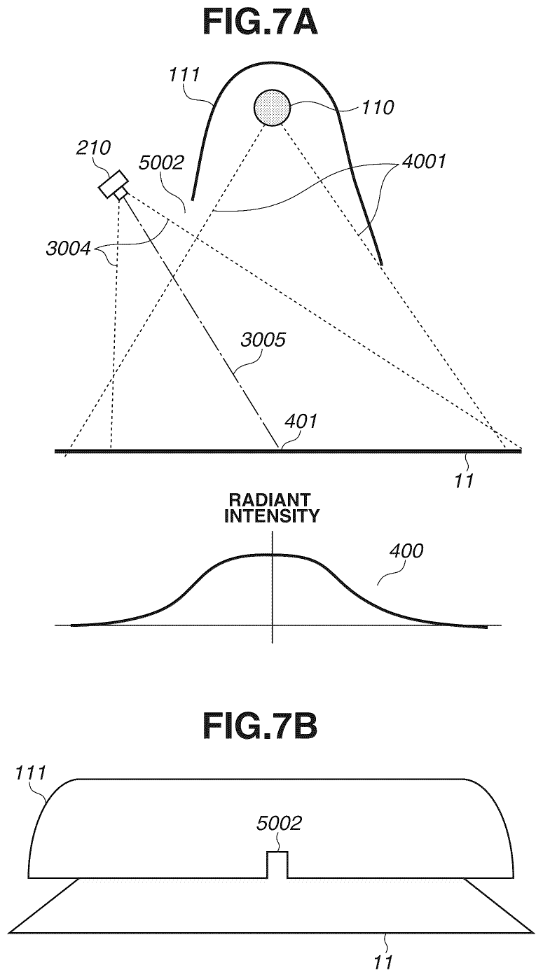

FIGS. 7A and 7B illustrate a suitable arrangement of the temperature sensor 210 and a shape of the reflector 111 for solving the issue described with reference to FIGS. 6A and 6B. In FIG. 7A, the temperature sensor 210 is arranged outside the heating area, and the center line 3005 is directed toward the center 401 of light collected by the reflector 111 as in FIGS. 6A and 6B. The example in FIG. 7A is different from the examples in FIGS. 6A and 6B in that an opening 5002 is formed in the reflector 111. The opening 5002 according to the present exemplary embodiment is a notch (also referred to as notch 5002), which is formed by cutting off a lower end of the reflector 111 in a vertical direction. Since the lower end of the reflector 111 is cut off, it is possible to suppress interference between the viewing angle 3004 and the reflector 111. Some of the radiant heat radiated from the heater 110 leaks through the notch 5002. Thus, the temperature sensor 210 may be arranged above, that is, a blind spot from the heater 110 so that a sensor body is not directly heated by the leaked radiant heat. For example, the temperature sensor 210, which is a temperature detection member, is arranged outside the reflector 111 and further arranged above the lower end of the reflector 111 on which the opening 5002 is formed in the vertical direction.

FIG. 7B is a bird's-eye view of the reflector 111 from the temperature sensor 210 side. The reflector 111 has the notch 5002 at a position where the temperature sensor 210 is attached. According to the present exemplary embodiment, the notch 5002 is formed in the center of the reflector 111 in a width direction. The center in the width direction is an area through which even a recording medium with the smallest size in the width direction passes. Thus, the heater heats the center of the recording medium during image formation, regardless of its size in the width direction. Therefore, it is desirable to arrange the temperature sensor 210 at the center in the width direction, and it is desirable to form the opening 5002 at the center in the width direction as well. In this way, the notch 5002 is formed only at the position where the temperature sensor 210 is attached rather than across an entire width of the first belt 11, and thus it is possible to minimize an effect on light collection performance of the reflector 111.

As described above, according to the present exemplary embodiment, the opening 5002 is provided in a part of the reflector 111, and thus the temperature sensor 210 can be arranged without reducing the belt temperature measurement accuracy. The present exemplary embodiment is merely an example, and the present disclosure is not limited to the configuration described here in the present exemplary embodiment. The position in the belt width direction, number, and size of the notches 5002 are not limited to the above-described configuration. According to the present exemplary embodiment, the temperature sensor 210 and the notch 5002 are arranged on a left side of the reflector 111 in the drawing, that is, on a downstream side of the reflector 111 in a moving direction of the first belt 11. However, the temperature sensor 210 and the notch 5002 may be arranged on a right side of the reflector 111 in the drawing, in other words, at least one of upstream or downstream ends of the reflector 111 in the conveyance direction of the recording medium.

According to the first exemplary embodiment, the example is described in which the notch 5002 is provided in the lower end of the reflector 111. According to a second exemplary embodiment, another example of a position and a shape of a notch are described.

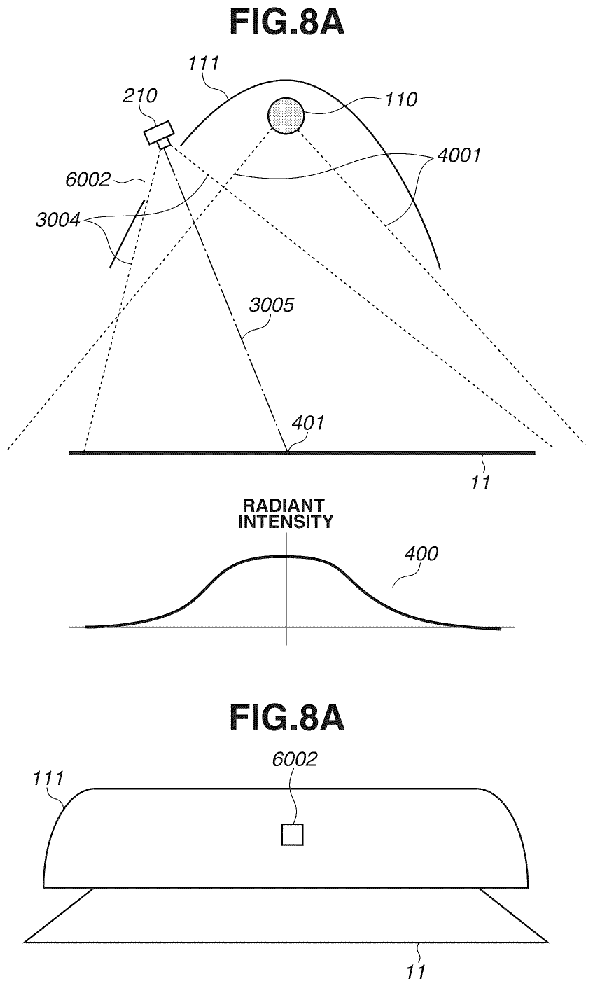

FIGS. 8A and 8B illustrate a suitable arrangement of the temperature sensor 210 and a shape of the reflector 111 according to the second exemplary embodiment. In FIG. 8A, the temperature sensor 210 is arranged outside the heating area, the center line 3005 is directed toward the center 401 of light collected by the reflector 111, and the reflector 111 does not interfere with the viewing angle 3004 as in FIG. 6A. A difference from FIG. 7A is that an opening 6002 on the left side of the reflector 111 is like a window, which is described below.

As in the first exemplary embodiment, the temperature sensor 210 may be arranged above, that is, a blind spot from the heater 110 so that the sensor body is not directly heated by the radiant heat leaked through the opening 6002.

FIG. 8B is a bird's-eye view of the reflector 111 from the temperature sensor 210 side. The reflector 111 has the opening 6002 at the position where the temperature sensor 210 is attached as in the first exemplary embodiment.

As described above, according to the present exemplary embodiment, the window-like opening 6002 is provided in a part of the reflector 111, so that the temperature sensor 210 can be arranged more desirably. Accordingly, even if the viewing angle 3004 of the temperature sensor 210 is wider than that according to the first exemplary embodiment, the heating area, which is an object of temperature detection, can fall within the viewing angle 3004. The present exemplary embodiment is merely an example, and the present disclosure is not limited to the configuration described here in the present exemplary embodiment. The position in the belt width direction, number, and size of the openings 6002 are not limited to the above-described configuration. The shape of the opening 6002 is not limited to a rectangle, but may be a circle, a triangle, or a polygon. Further, according to the present exemplary embodiment, the temperature sensor 210 and the opening 6002 are arranged on the left side of the reflector 111 in the drawing, that is, on the downstream side of the reflector 111 in the moving direction of the first belt 11. However, the temperature sensor 210 and the opening 6002 may be arranged on the right side of the reflector 111 in the drawing, in other words, at least one of the upstream or downstream ends of the reflector 111 in the conveyance direction of the recording medium.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-140541, filed Aug. 30, 2023, which is hereby incorporated by reference herein in its entirety.

What is claimed is:

1. An ink jet recording apparatus comprising:
an ink image forming unit configured to form an ink image on a recording medium; and
a fixing apparatus arranged downstream of the ink image forming unit in a conveyance direction of the recording medium and configured to fix the ink image on the recording medium while pinching and conveying the recording medium,
wherein the fixing apparatus includes:
a first belt configured to rotate and come into contact with the ink image formed by the ink image forming unit;
a rotating member configured to come into contact with the first belt to form a nip portion;
a heater arranged inside the first belt and configured to heat the nip portion without contact;
a reflector configured to cover an upper portion of the heater and to reflect radiant heat from the heater toward an inner circumferential surface of the first belt in the nip portion;
an opening formed on the reflector; and
a temperature detection member arranged inside the first belt and configured to detect a temperature of a heating area of the heater on the first belt without contact,
wherein the temperature detection member is arranged to detect a temperature of the first belt from the opening.

2. The ink jet recording apparatus according to claim 1, wherein the opening is a window-like opening provided in a part of the reflector.

3. The ink jet recording apparatus according to claim 1, wherein the reflector has an opening at a position where the temperature detection member is attached.

4. The ink jet recording apparatus according to claim 1, wherein the opening is a notch formed at one of an upstream end or a downstream end of the reflector in the conveyance direction of the recording medium.

5. The ink jet recording apparatus according to claim 1, wherein the reflector does not interfere with a viewing angle of the temperature detection member.

6. The ink jet recording apparatus according to claim 1, wherein the temperature detection member is located outside the reflector.

7. The ink jet recording apparatus according to claim 1, wherein a notch is formed at a center in a width direction of the first belt.
